(19) United States
(12) Patent Application Publication
(10) Pub. No.: US 2011/0268851 A1
(43) Pub. Date: Nov. 3, 2011

(54) SYSTEMS AND METHODS FOR MEAT PROCESSING

(75) Inventor: Patrick Howard Hawkins, Blaine, MN (US)

(73) Assignee: HAWKINS, INC., Minneapolis, MN (US)

(21) Appl. No.: 12/914,804

(22) Filed: Oct. 28, 2010

Related U.S. Application Data
(62) Division of application No. 11/177,931, filed on Jul. 8, 2005, now abandoned.

(51) Int. Cl. A23B 4/02

(52) U.S. Cl. 426/231

(57) ABSTRACT

The invention relates to systems and methods for maintaining the concentration of a brine solution used in meat processing. In an embodiment, a method includes measuring a concentration property of brine solution in a reservoir with a sensor; supplying data regarding the concentration property of the brine solution to a controller; removing diluted brine solution from the reservoir when the controller determines that the concentration property falls below a defined set point; adding a liquid composition comprising greater than about 50 wt. % of a potassium phosphate salt to the reservoir from a phosphate solution supply tank when the controller determines that the concentration property falls below a defined set point; and replenishing the phosphate solution supply tank by adding a liquid phosphate salt composition having a consistent concentration to the phosphate solution supply tank. Other embodiments are included herein.

This application is a divisional of prior application Ser. No. 11/177,931, filed Jul. 8, 2005, the content of which is herein incorporated by reference in its entirety.

### FIELD OF THE INVENTION

The invention relates to systems and methods for meat processing. More specifically, the invention relates to systems and methods for controlling salt concentration in a brine solution used for treating sausage casings.

### BACKGROUND OF THE INVENTION

To make sausage products, ingredients for the filling are generally prepared, mixed, and/or emulsified, and then stuffed into casings. Casings can give the sausage product shape and hold the product together for further processing. After the filling is stuffed into the casings, the product may be tied with thread or fastened with metal clips and then subjected to further processing such as smoking, cooking, drying, chilling, etc.

Historically, sausage casings have been of a finite length. The use of casings having a finite length meant that only a given amount of filling could be stuffed into a single casing before another casing would have to be used. Therefore, the use of finite length casings is generally considered to be less conducive to high volume sausage product manufacturing.

In sausage making processes such as those disclosed in U.S. Pat. No. 6,054,155 to Kobussen, et al., herein incorporated by reference, the sausage filling is co-extruded along with a collagen gel that forms the casing. After co-extrusion, the collagen gel is dehydrated and coagulated, resulting in a casing having the strength and functionality necessary for further processing. Dehydration and coagulation are enhanced by contacting the sausage product with a brine solution. In this process, water transferred from the collagen casing dilutes the brine solution. As a result, the concentration of the brine solution must be periodically checked and/or restored.

Consistency is a highly desired quality in the manufacture of food products. The consistency of sausage products can be affected by the consistency of the brine solution used. As the brine solution is diluted by water from the sausage product, its ability to dehydrate the collagen casing is reduced. Therefore, the casing of a sausage product that passes through a relatively diluted brine solution may be less crisp or firm than a sausage product that passes through an undiluted brine solution, resulting in lower quality and less consistency.

Therefore, a need exists for methods and systems for maintaining the concentration of a brine solution used in meat processing. A need also exists for methods and systems of increasing the consistency of brine solutions used in meat processing.

### SUMMARY OF THE INVENTION

The invention relates to systems and methods for controlling salt concentration in a brine solution using a liquid potassium phosphate composition. In an embodiment, the invention includes a method for operating a meat product processing machine including removing a diluted brine solution from a reservoir and adding a liquid composition comprising greater than about 50 wt. % of a potassium phosphate salt to the reservoir.

In an embodiment, the invention includes a method for processing meat products including forming a meat product, contacting the meat product with a salt solution, removing diluted salt solution from the reservoir, and adding a liquid salt composition comprising greater than about 50 wt. % of a potassium phosphate salt to the reservoir.

In an embodiment, the invention includes a method for treating meat products including contacting a meat product having a casing with a salt solution, removing diluted salt solution from the reservoir, and adding a liquid composition comprising greater than about 50 wt. % of a potassium phosphate salt to the reservoir.

In an embodiment, the invention includes a method for automatically controlling salt concentrations in a meat processing reservoir including measuring a concentration property of a solution with a sensor, discarding a portion of the solution, and adding a liquid salt composition comprising greater than about 50 wt. % of a potassium phosphate salt to the reservoir.

In an embodiment, the invention includes a method for maintaining the concentration of a brine solution used in meat processing including measuring a concentration property of brine solution, removing diluted brine solution from a reservoir, and adding a liquid composition comprising greater than about 50 wt. % of a potassium phosphate salt to the reservoir.

In an embodiment, the invention includes a meat processing apparatus including a reservoir configured to hold a brine solution, a concentration sensor coupled to the reservoir, a controller in electronic communication with the concentration sensor, a discharge valve in fluid communication with the reservoir, a supply valve in fluid communication with the reservoir, and a liquid salt concentrate supply tank in fluid communication with the supply valve.

The above summary of the present invention is not intended to describe each discussed embodiment of the present invention. This is the purpose of the figures and the detailed description that follows.

### DRAWINGS

The invention may be more completely understood in connection with the following drawings, in which:

FIG. 1 is a flowchart of an exemplary sausage making process.

FIG. 2 is a schematic diagram of a brine treatment process in accordance with an embodiment of the invention.

FIG. 3 is a schematic diagram of a brine reservoir system in accordance with an embodiment of the invention.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

In many sausage manufacturing processes, the sausage filling is co-extruded along with a collagen containing composition that forms the casing. After co-extrusion, the collagen gel is dehydrated and the collagen protein structure is coagulated to have the strength and functionality necessary for further handling and processing. Contacting the nascent sausage product with a brine solution enhances dehydration and coagulation. As the sausage product is exposed to the brine solution, water is transferred from the sausage product to the brine solution, diluting the brine solution. The ability of the brine solution to dehydrate the collagen casing is reduced as the brine solution is diluted by water from the sausage product. Therefore, the concentration of the brine solution must generally be checked and/or restored periodically.

One approach to restoring the concentration of the brine solution is to add additional quantities of phosphate salts, such as dipotassium phosphate, in solid form. For example, dipotassium phosphate can be added as granules. However, adding phosphate salts as a solid typically requires a manual process of measuring a desired amount and then mixing it into the brine solution sufficiently so that it is substantially dissolved. If too much solid phosphate salt is added, some amount may remain undissolved and interfere with operation of the sausage making equipment. Further adding to the negative aspects of this approach, some phosphate salts, such as dipotassium phosphate, are hygroscopic and therefore require special storage conditions.

Use of a liquid phosphate salt composition can avoid some of the limitations associated with use of a solid phosphate salt. However, liquid solutions of dipotassium phosphate, for example, have generally only been commercially available in the past with a maximum concentration of 50 wt. % dipotassium phosphate. For reference, a liquid solution of 50 wt. % dipotassium phosphate in water has a specific gravity of approximately 1.54 at ambient temperature.

Brine solutions containing dipotassium phosphate used in sausage making are generally targeted to have a specific gravity in the range of 1.3-1.55. Assuming that a particular sausage making operation targets a specific gravity of 1.44, where the specific gravity of 100 gallons of brine solution is measured and found to be 1.34, one would have to add 100 gallons of a 50 wt. % dipotassium phosphate stock solution (having a specific gravity of 1.54) in order to restore the specific gravity of the brine solution to 1.44. Adding such a large relative volume of phosphate salt stock solution is not desired because an approximately equal amount of the brine solution must be discharged to make room in the brine solution reservoir. This results in a relatively large amount of phosphate salts being discharged as waste, which can be economically inefficient.

Applicants have discovered that utilizing liquid phosphate salt compositions having a phosphate salt concentration of greater than 50 wt. % can enhance the process of replenishing phosphate salt brine solutions. In an embodiment, the invention includes a method for operating a meat product processing machine including removing a diluted brine solution from a reservoir, and adding a liquid composition comprising greater than about 50 wt. % of a potassium phosphate salt to the reservoir. In an embodiment, the invention includes a method for processing meat products including forming a meat product, contacting the meat product with a salt solution, removing diluted salt solution from the reservoir, and adding a liquid salt composition comprising greater than about 50 wt. % of a potassium phosphate salt to the reservoir. In an embodiment, the invention includes a method for treating meat products including contacting a meat product having a casing with a salt solution, removing diluted salt solution from the reservoir, and adding a liquid composition comprising greater than about 50 wt. % of a potassium phosphate salt to the reservoir.

Consistency of food products is generally highly desired. Food product consistency can relate to texture, color, taste, etc. The consistency of sausage products can be affected by the consistency of the brine solution the products are treated with. Specifically, a sausage product that passes through a relatively diluted brine solution may be less crisp or firm than a sausage product that passes through an undiluted brine solution. In many current processes, the concentration properties of the brine solution are manually checked and adjusted periodically such as once every half-hour or once an hour. This relatively long periodicity allows for larger variations in brine solution consistency. Further, as a manual process, it is difficult to ensure that operators of the equipment will regularly check and adjust the brine solution concentration.

It is believed that controlling the consistency of the brine solution more tightly results in an increase of the consistency of the finished sausage product. In an embodiment, the invention includes a method for automatically controlling salt concentrations in a meat processing reservoir including measuring a concentration property of a solution with a sensor, the sensor sending concentration information to a controller, discarding a portion of the solution by sending a signal from the controller to a discharge valve, and adding a liquid salt composition comprising greater than about 50 wt. % of a potassium phosphate salt to the reservoir by sending a signal from the controller to a supply valve. In an embodiment, the invention includes a meat processing apparatus including a reservoir configured to hold a brine solution, a concentration sensor coupled to the reservoir, a controller in electronic communication with the concentration sensor, a discharge valve in fluid communication with the reservoir, a supply valve in fluid communication with the reservoir, and a liquid salt concentrate supply tank in fluid communication with the supply valve, wherein the controller is in electronic communication with the discharge valve and the supply valve, the controller configured to add liquid salt concentrate to the reservoir when the concentration falls below a set point.

The term “sausage product”, as used herein, shall refer to all sausage-like products including without limitation fresh sausage, bratwurst, smoked sausage, mettwurst, kielbasa, frankfurters, hot dogs, bologna, salami, dry sausage, pepperoni, cervelot, summer sausage, thuringer, and the like.

The term “substantially dissolved”, as used herein, shall refer to the state wherein a solute is dissolved in a solvent and no more than trace amounts of the solute remain undissolved.

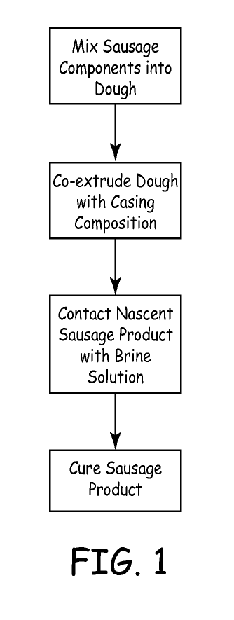

Referring now to FIG. 1, a flowchart of an exemplary sausage making process is shown. Sausage components are prepared and then mixed into sausage dough. Sausage components can include meats, fillers, seasonings, spices, binders, preservatives, and the like. In some embodiments, the sausage dough can be an emulsion. The dough is then co-extruded with a casing composition. Co-extrusion gives the sausage product its tubular shape and deposits a thin layer of the casing composition on the outside of the sausage dough. The casing composition may include components such as collagen, starch, cross-linkers, etc. Various possible casing components are described in U.S. Patent Application Publication 2004/0091581, the contents of which is herein incorporated by reference.

After co-extrusion, the nascent sausage product is then contacted with a brine solution containing a phosphate salt. The sausage product may physically pass through a tank of brine solution or a brine solution may be sprayed onto the sausage product. It will be appreciated that the brine solution may be applied to the sausage product in many different ways. The brine solution removes water from the casing composition and can also function to help coagulate or cross-link the components of the casing composition. After contacting the brine solution, the sausage product moves on for curing. Curing can include further processing steps such as smoking, cooking, drying, chilling, and the like.

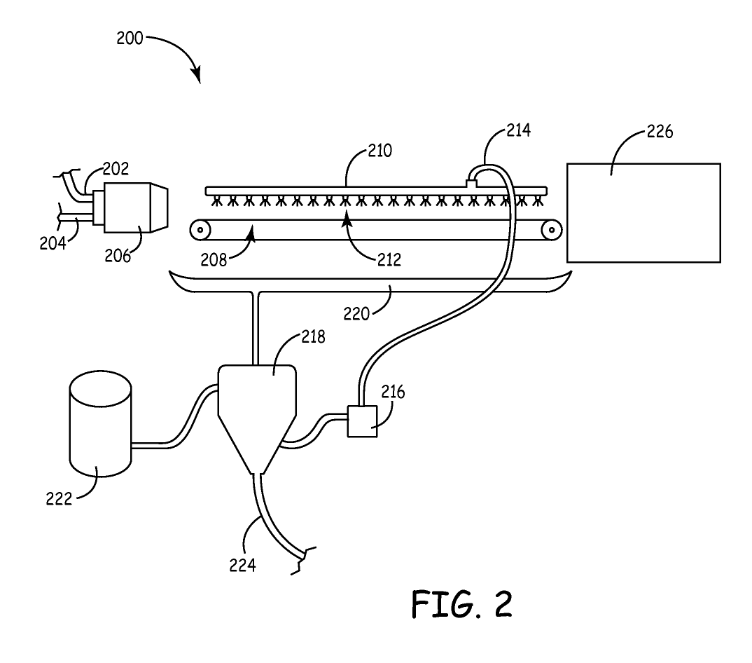

Referring now to FIG. 2, a schematic diagram of a brine treatment process 200 is shown. A sausage dough supply tube 202 and a casing composition supply tube 204 feed into a co-extruder 206 where the sausage dough and casing composition are co-extruded to produce a nascent sausage product (not shown). The nascent sausage product is then fed onto a conveyor system 208 which passes under a brine solution spray station 210 having a plurality of spray heads 212. It will be appreciated that the conveyor system 208 may be configured in many different ways. Brine solution coming from a brine solution supply line 214 is then sprayed onto the nascent sausage product. A pump 216 that is connected to a brine reservoir 218 pushes brine solution through the brine solution supply line 214. After the nascent sausage product passes under the brine solution spray station 210, it moves on to further equipment 226 for further processing.

Brine solution that has been sprayed onto the nascent sausage product flows down to be collected in a brine solution collection tray 220. The collected brine solution then flows back to the brine reservoir 218. As the brine solution removes water from the nascent sausage product, the brine solution can become diluted. A phosphate salt solution supply tank 222 stores phosphate salt solution feed stock that can be added to the brine reservoir in order to increase the phosphate salt concentration of the brine solution. Phosphate salts and phosphate salt solutions suitable for use with embodiments of the invention are described in greater detail below.

In the system shown in FIG. 2, the brine reservoir 218 has a finite volume. Therefore, in conjunction with the addition of phosphate salt solution feed stock, some of the diluted brine solution is removed from the brine reservoir 218 through an effluent waste line 224 in order to maintain a relatively constant volume of brine solution in the brine reservoir 218.

While the brine solution is sprayed onto the nascent sausage product in the schematic diagram of FIG. 2, it will be appreciated that there are many different ways in which the brine solution can be applied to the sausage product. By way of example, the sausage product could pass through a tank (or bath) containing the brine solution. Alternatively, the brine solution could be brushed on, rolled on, or dripped onto the nascent sausage product.

The phosphate salt solution supply tank 222 may be periodically replenished with a liquid phosphate salt composition as described in more detail below. While not intending to be bound by theory, it is believed that the addition of a liquid phosphate salt composition is more convenient and results in greater brine solution consistency because of difficulties associated with mixing solid phosphate salts into the supply tank or into the brine reservoir directly.

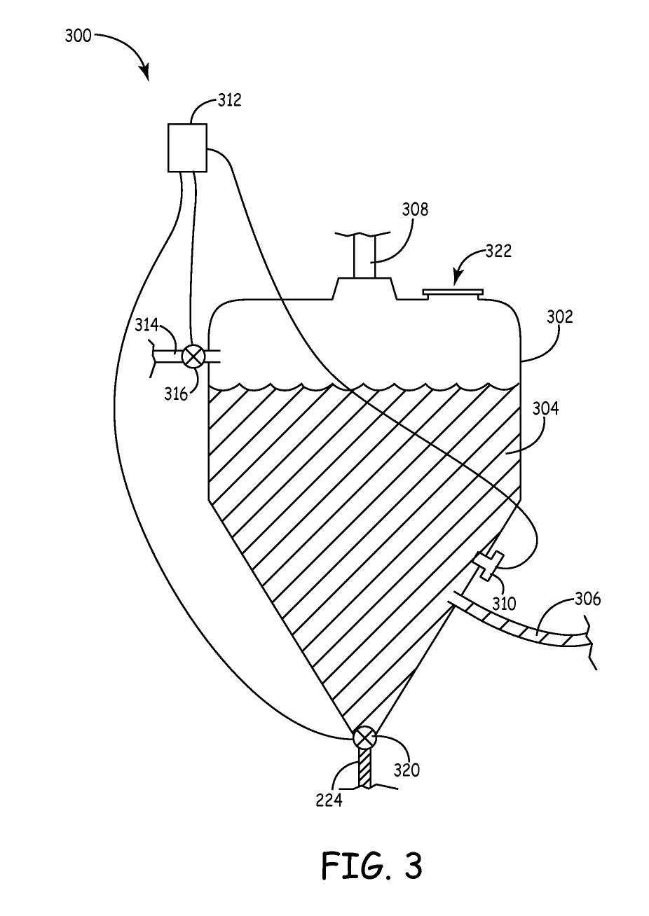

Referring now to FIG. 3, a schematic diagram of a brine reservoir system 300 in accordance with an embodiment of the invention is shown. A reservoir 302 defines an enclosed volume in which brine solution 304 is stored. To be applied to sausage product, the brine solution 304 can pass from the reservoir 302 to a pump 216 (shown in FIG. 2) through a channel 306. Brine solution returning from the brine solution collection tray 220 (shown in FIG. 2) can flow back into the reservoir 302 through a return port 308. The return port 308 may optionally include a filter (not shown) to remove matter from the brine solution 304 that is being returned to the reservoir 302.

A sensor 310 can be coupled to the reservoir 302 in order to measure concentration properties of the brine solution 304. In an embodiment, the sensor 310 can measure the specific gravity of the brine solution 304. In an embodiment, the sensor 310 can measure the refractive index of the brine solution 304. In an embodiment, the sensor 310 can measure (directly or indirectly) the concentration of phosphate salt in the brine solution 304. It will be appreciated that there are many ways that a sensor can measure the concentration of phosphate salt either directly or indirectly. An exemplary sensor is the PRINCO DENSITROL specific gravity monitor available from Princo Instruments, Inc., Southampton, Pa. The sensor can provide data to the controller either periodically or continuously.

The sensor can be in electronic communication with a controller 312, such as a PLC controller. The sensor can provide data on concentration properties of the brine solution 304 to the controller 312. The sensor can relay data to the controller through either wired or wireless techniques. The controller 312 can be in electronic communication with a feed stock input valve 316 and an effluent waste valve 320. The controller 312 can cause the feed stock input valve 316 and/or the effluent waste valve 320 to open or close. By way of example, when a concentration property of the brine solution falls below a defined level, the controller can cause the feed stock input valve 316 to be opened so that phosphate salt feed stock solution is added to the reservoir 302 from a phosphate salt feed stock line 314. As a further example, the controller 312 can open the effluent waste valve 320 to eliminate some of the brine solution through the effluent waste line 224.

Opening of the effluent waste valve 320 can be done in coordination with, or independently of, the feed stock input valve 316 being opened so that phosphate salt feed stock solution can be added to the reservoir. In some embodiments, elimination of diluted brine solution is performed before the addition of phosphate salt feed stock solution. In some embodiments, elimination of brine solution is performed after the addition of phosphate salt feed stock solution. In other embodiments, these steps are performed simultaneously.

The reservoir 302 may also include one or more volume sensors (not shown) to detect the volume of brine solution 304 in the reservoir 302. The volume sensor(s) can be in electronic communication with the controller 312. As an example, the controller 312 can cause the effluent waste valve 320 to be opened to eliminate some of the brine solution through the effluent waste line 224 when the volume of brine solution 304 has exceeded a defined volume.

The reservoir 302 may also contain a stirring device such as a paddle (not shown) in order to keep the brine solution 304 in the reservoir 302 well-mixed. The reservoir 302 may also have an access hatch 322.

### Phosphate Salts and Phosphate Salt Solutions

In an embodiment, the invention includes the addition of a liquid composition comprising greater than about 50 wt. % of a phosphate salt to a brine reservoir. Phosphate salts can include potassium phosphate salts. In a particular embodiment, the phosphate salt is dipotassium phosphate (K₂HPO₄). Liquid compositions comprising greater than about 50 wt. % dipotassium phosphate are commercially available from Hawkins Inc., Minneapolis, Minn.

The phosphate salt solution of the invention can also include amounts of other phosphate salts. By way of example the phosphate salt solution can include monopotassium phosphate, tetrapotassium pyrophosphate, potassium tripolyphosphate, monosodium phosphate, disodium phosphate, tetrasodium pyrophosphate, sodium tripolyphosphate, sodium hexametaphosphate, and sodium acid pyrophosphate. Combinations of different phosphate salts can be used. The phosphate salt solution can also include other components such as browning agents, flavorings, etc.

In an embodiment, the phosphate salts of the invention are in a liquid composition. The phosphate salt concentration of the liquid composition should be sufficient to efficiently raise the concentration of the brine solution in the brine reservoir of a meat processing machine to a useful level. In an embodiment, the phosphate salt concentration of the liquid composition is greater than about 50 wt. %. Phosphate salt concentration of the liquid composition should be low enough so that the liquid composition is not excessively unstable at operating temperatures and pressures. In an embodiment, the phosphate salt concentration is lower than about 90 wt. %. In an embodiment, the phosphate salt concentration is from about 55 wt. % to about 73 wt. %. In an embodiment, the phosphate salt concentration is from about 60 wt. % to about 68 wt. %.

It is believed that dipotassium phosphate dissolved in water at concentrations greater than about 62 wt. % to about 64 wt. % (depending on pressure) must be heated in order to have sufficient stability while being stored in a phosphate salt solution supply tank. In some embodiments, the phosphate salt liquid composition is heated. In some embodiments, the phosphate salt liquid composition is at ambient temperature.

### Further Embodiments of the Invention

In an embodiment, the invention includes a method for operating a meat product processing machine including removing a diluted brine solution from a reservoir and adding a liquid composition comprising greater than about 50 wt. % of a potassium phosphate salt to the reservoir. The method can include measuring the specific gravity of the diluted brine solution in the reservoir. The step of measuring the specific gravity can be performed before the step of removing a diluted brine solution. The liquid composition can include from about 60 wt. % to about 68 wt. % of a potassium phosphate salt. The potassium phosphate salt can include dipotassium phosphate. The liquid composition can have a specific gravity of about 1.7. The meat product processing machine can be a sausage processing machine. The liquid composition can be heated. The solids of the liquid composition can be substantially dissolved. The step of adding a liquid composition can raise the specific gravity of the brine solution. The step of adding a liquid composition can raise the specific gravity of the brine solution to a specific gravity of about 1.3 to about 1.55.

In an embodiment, the invention includes a method for processing meat products including forming a meat product by coextruding a meat composition and a casing composition, contacting the meat product with a salt solution, the salt solution stored in a reservoir, wherein water is transferred from the meat product to the salt solution forming a diluted salt solution, removing diluted salt solution from the reservoir, and adding a liquid salt composition comprising greater than about 50 wt. % of a potassium phosphate salt to the reservoir. The liquid salt composition can include from about 60 wt. % to about 68 wt. % of a potassium phosphate salt. The potassium phosphate salt can be dipotassium phosphate. The liquid composition can have a specific gravity of about 1.7. The casing composition can include collagen. The meat product can be sausage. The liquid salt composition can be heated. The solids of the liquid salt composition can be substantially dissolved. The step of adding a liquid salt composition can raise the specific gravity of the solution in the reservoir. The step of adding a liquid salt composition can raise the specific gravity of the solution in the reservoir to a specific gravity of about 1.3 to about 1.55.

In an embodiment, the invention includes a method for treating meat products including contacting a meat product having a casing with a salt solution, the salt solution stored in a reservoir, wherein water is transferred from the meat product to the salt solution forming a diluted salt solution, removing diluted salt solution from the reservoir, and adding a liquid composition comprising greater than about 50 wt. % of a potassium phosphate salt to the reservoir. The liquid composition can include from about 60 wt. % to about 68 wt. % of a potassium phosphate salt. The potassium phosphate salt can be dipotassium phosphate. The liquid composition can have a specific gravity of about 1.7. The casing can include collagen. The meat product can be sausage. The liquid composition can be heated. The solids of the liquid composition can be substantially dissolved. The step of adding a liquid composition can raise the specific gravity of the solution in the reservoir. The step of adding a liquid composition can raise the specific gravity of the solution in the reservoir to a specific gravity of about 1.3 to about 1.55.

In an embodiment, the invention includes a method for treating meat products including contacting a meat product having a collagen casing with a salt solution, the salt solution stored in a reservoir, wherein water is transferred from the meat product to the salt solution reducing the specific gravity of the salt solution, removing salt solution from the reservoir, and increasing the specific gravity of the salt solution in the reservoir by adding a liquid salt composition comprising greater than about 50 wt. % of a potassium phosphate salt to the reservoir.

In an embodiment, the invention includes a method for automatically controlling salt concentrations in a meat processing reservoir including measuring a concentration property of a solution with a sensor, the sensor sending concentration information to a controller, discarding a portion of the solution by sending a signal from the controller to a discharge valve, and adding a liquid salt composition comprising greater than about 50 wt. % of a potassium phosphate salt to the reservoir by sending a signal from the controller to a supply valve. The sensor can measure salt concentration. The sensor can measure specific gravity. The sensor can continuously measure a concentration property. The controller can be a PLC controller. The liquid salt composition can include from about 60 wt. % to about 68 wt. % of a potassium phosphate salt. The potassium phosphate salt can include dipotassium phosphate. The meat product can be sausage. The liquid salt composition can be heated. The solids of the liquid salt composition can be substantially dissolved.

In an embodiment, the invention includes a meat processing apparatus including a reservoir configured to hold a brine solution, a concentration sensor coupled to the reservoir, a controller in electronic communication with the concentration sensor, a discharge valve in fluid communication with the reservoir, a supply valve in fluid communication with the reservoir, and a liquid salt concentrate supply tank in fluid communication with the supply valve, wherein the controller is in electronic communication with the discharge valve and the supply valve, the controller configured to add liquid salt concentrate to the reservoir when the concentration falls below a set point. The controller can be configured to open and then close the supply valve to add liquid salt concentrate to the reservoir. The controller can be configured to discard brine solution from the reservoir when the concentration falls below a set point. The controller can be configured to open and close the discharge valve to discard brine solution.

In an embodiment, the invention includes a method for maintaining the concentration of a brine solution used in meat processing including measuring a concentration property of brine solution, removing diluted brine solution from a reservoir, adding a liquid composition comprising greater than about 50 wt. % of a potassium phosphate salt to the reservoir. The step of measuring a concentration property of brine solution can be performed continuously. The steps of removing diluted brine solution and adding a liquid composition can be performed when the concentration property falls below a defined set point. The concentration property can be specific gravity. The concentration property can be concentration of dipotassium phosphate.

While the present invention has been described with reference to several particular implementations, those skilled in the art will recognize that many changes may be made hereto without departing from the spirit and scope of the present invention.

The claims are:

1. A method for maintaining the concentration of a brine solution used in meat processing comprising:
measuring a concentration property of brine solution in a reservoir with a sensor;
supplying data regarding the concentration property of the brine solution to a controller;
removing diluted brine solution from the reservoir when the controller determines that the concentration property falls below a defined set point;
adding a liquid composition comprising greater than about 50 wt. % of a potassium phosphate salt to the reservoir from a phosphate solution supply tank when the controller determines that the concentration property falls below a defined set point; and
replenishing the phosphate solution supply tank by adding a liquid phosphate salt composition having a consistent concentration to the phosphate solution supply tank.

2. The method of claim 1, wherein the step of measuring a concentration property of the brine solution is performed continuously.

3. The method of claim 1, wherein the concentration property comprises specific gravity.

4. The method of claim 1, wherein the concentration property comprises the concentration of dipotassium phosphate.

5. The method of claim 1, wherein the step of adding a liquid composition comprises adding a liquid salt composition comprising from about 55 wt. % to about 73 wt. % of a potassium phosphate salt to the reservoir from a phosphate solution supply tank.

6. The method of claim 1, wherein the step of adding a liquid composition comprises adding a liquid salt composition comprising from about 60 wt. % to about 68 wt. % of a potassium phosphate salt.

7. The method of claim 1, the potassium phosphate salt comprising dipotassium phosphate.

8. The method of claim 1, the liquid phosphate salt composition having a specific gravity of about 1.7.

9. The method of claim 1, wherein adding the liquid composition raises the specific gravity of the solution in the reservoir to a specific gravity of about 1.3 to about 1.55.

10. The method of claim 1, the sensor comprising a specific gravity monitor.
